(19) United States
(12) Patent Application Publication
(10) Pub. No.: US 2007/0050275 A1
(43) Pub. Date: Mar. 1, 2007

(54) Method and system for purchasing commodities

(76) Inventor: Calvin E. Hunsicker, Bartlett, NH (US)

Correspondence Address: HAYES SOLOWAY PC, 175 Canal Street, Manchester, NH, 03101, US

(21) Appl. No.: 11/212,238

(22) Filed: Aug. 26, 2005

(51) Int. Cl. G06Q 40/00

(52) U.S. Cl. 705/35

(57) ABSTRACT

A method of purchasing a commodity at a low price is provided. The method involves gathering commodity-pricing information from at least one commodity-providing source periodically. The commodity-pricing information is uploaded to a commodity database periodically. A specific commodity contained within the commodity database and attached to commodity-pricing information is identified. A lowest cost provider is determined from the commodity-providing sources using the commodity-pricing information attached to the specific commodity. The specific commodity is purchased using the information provided.

### FIELD OF THE INVENTION

The present invention is in the field of purchasing software and, more specifically, is in the field of software for the purchasing of commodities.

### BACKGROUND OF THE INVENTION

Many industries require the regular purchase of commodities (or at least commodities within the appropriate field) to operate a business. Manufacturers regularly purchase parts of a product to be manufactured from other suppliers. Restaurants are regularly ordering food, linens, and paper products. General contractors are regularly ordering building materials. Mechanics are constantly ordering automotive parts. Hospitals and pharmacies are regularly ordering various medicines or medical ingredients. The responsibility of ordering these commodities on a weekly, if not daily, basis can be time consuming.

Commodity purchasers often buy from more than one commodity provider. The commodity providers revise their pricing on a weekly, if not daily, basis to try to maintain a competitive sales price while also adjusting for their fluctuating costs. As a result, commodity purchasers are forced to compare the pricing of each commodity they are purchasing with regards to the pricing from each provider on a daily basis to attempt to make purchases at the lowest cost. Some purchasers will also develop special contracts with providers to attempt to maintain a fixed price for one or more specific commodity for a fixed time frame, which may also carry some purchasing requirements for the purchaser. Some pricing may be specially set for groups of purchasers who wish to buy through a group purchasing organization, which may help lower pricing. All of these sources of commodities make identifying the lowest price for a commodity difficult.

Another issue for many purchasers is quality of the goods. Some restaurants may require a minimum quality level for their linens, while others may simply be looking for paper napkins that fit within their dispenser. Some doctors may prescribe a specific medication, but may or may not be willing to substitute the generic equivalent. Another responsibility of commodity purchasers is identifying the quality of goods desired or the scope of equivalents that will be acceptable. Equivalents invariably increase the number of prices to be reviewed for the various commodities.

Also, all of this price changing can be confusing for the commodity provider as well as the commodity purchaser. In some industries, commodity providers make mistakes regarding pricing on about one percent of the commodities sold. The commodity purchaser needs to keep accurate notes regarding all purchases and purchase prices agreed to and verify those notes and prices when the commodity is billed.

For all of these reasons, purchasing commodities is highly time-consuming. In many cases, the person handling commodity purchasing is responsible for other tasks and cannot devote the time needed to purchasing commodities. As a result, inefficient purchases are made frequently and other mistakes are made.

Thus, a heretofore unaddressed need exists in the industry to address the aforementioned deficiencies and inadequacies.

### SUMMARY OF THE INVENTION

Embodiments of the present invention provide a system and method for gathering commodity-pricing information. Briefly described in steps, one embodiment of the method, among others, can be implemented as follows: gathering commodity-pricing information from at least one commodity-providing source periodically; uploading the commodity-pricing information to a commodity database periodically; identifying a specific commodity contained within the commodity database and attached to commodity-pricing information; determining a lowest cost provider from the commodity-providing sources using the commodity-pricing information attached to the specific commodity; and purchasing the specific commodity.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a block diagram of a purchasing system, in accordance with a first exemplary embodiment of the present invention.

FIG. 2 is a flowchart illustrating a method of practicing the purchasing system of FIG. 1, in accordance with the first exemplary embodiment of the invention.

FIG. 3 is a flowchart illustrating a method of practicing the purchasing system of FIG. 1, in accordance with the second exemplary embodiment of the invention.

FIG. 4 is a flowchart illustrating a method of practicing the purchasing system of FIG. 1, in accordance with the third exemplary embodiment of the invention.

FIG. 5 is a flowchart illustrating a method of practicing the purchasing system of FIG. 1, in accordance with the fourth exemplary embodiment of the invention.

FIG. 6 is a flowchart illustrating a method of practicing the purchasing system of FIG. 1, in accordance with the fifth exemplary embodiment of the invention.

FIG. 7 is a flowchart illustrating a method of practicing the purchasing system of FIG. 1, in accordance with a sixth exemplary embodiment of the invention.

### DETAILED DESCRIPTION

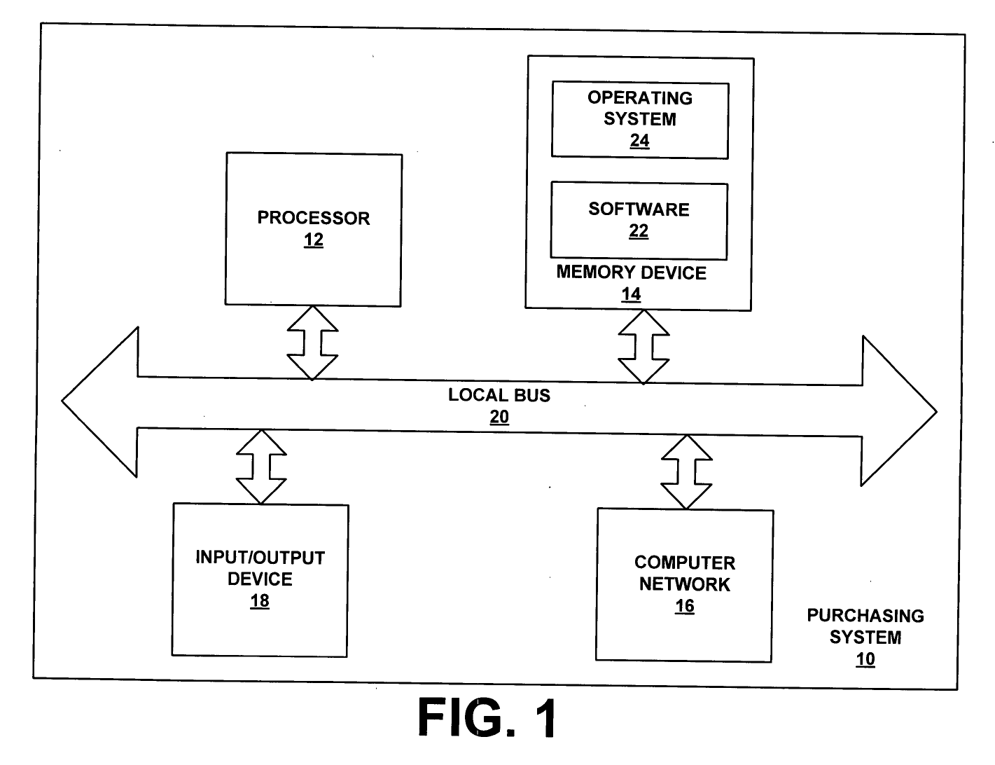

FIG. 1 is a block diagram of a purchasing system 10, in accordance with a first exemplary embodiment of the present invention. The purchasing system 10 includes a processor 12 in communication with a memory device 14. The processor 12 is further in connection with a computer network 16. The processor 12 is arranged to receive commodity-pricing information through the computer network 16 periodically. The commodity-pricing information is received from at least one commodity-providing source. The commodity-pricing information is stored in a commodity database within the memory device 14. At least one input/output (I/O) device 18 is in communication with the processor 12, through which a specific commodity may be identified. The processor 12 filters through the commodity-pricing information to determine if pricing exists from at least one commodity-providing source for the specific commodity. If pricing exists from at least one commodity-providing source for the specific commodity, the processor 12 determines a lowest cost provider from the commodity-pricing information and provides the information to the I/O devices 18. A user may then purchase the specific commodity armed with information regarding the lowest cost provider. A local bus 20, or a similar device known to those having ordinary skill in the art, may further be provided between the other elements of the purchasing system 10 to enable communication between those elements.

The processor 12 is a hardware device for executing software 22, particularly that which is stored in the memory device 14. The processor 12 can be any custom made or commercially available processor, a central processing unit (CPU), an auxiliary processor among several processors associated with the computer, a semiconductor based microprocessor (in the form of a microchip or chip set), a macroprocessor, or generally any device for executing software instructions. Examples of suitable commercially available microprocessors are as follows: a PA-RISC series microprocessor from Hewlett-Packard Company, an 80x86 or Pentium series microprocessor from Intel Corporation, a PowerPC microprocessor from IBM, a Sparc microprocessor from Sun Microsystems, Inc, or a 68xxx series microprocessor from Motorola Corporation.

The memory device 14 can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory device 14 may incorporate electronic, magnetic, optical, and/or other types of storage media. Note that the memory device 14 may have a distributed architecture, where various components are situated remote from one another, but can be accessed by the processor 12.

The software 22 in the memory device 14 may include one or more separate programs, each of which comprises an ordered listing of executable instructions for implementing logical functions. In the example of FIG. 1, the software 22 in the memory device 14 defines the functionality performed by the purchasing system 10. A suitable operating system (O/S) 24 may also be stored within the memory device 14. A nonexhaustive list of examples of suitable commercially available operating systems 24 is as follows: (a) a Windows operating system available from Microsoft Corporation; (b) a Netware operating system available from Novell, Inc.; (c) a Macintosh operating system available from Apple Computer, Inc.; (d) a UNIX operating system, which is available for purchase from many vendors, such as the Hewlett-Packard Company, Sun Microsystems, Inc., and AT&T Corporation; (e) a LINUX operating system, which is freeware that is readily available on the Internet; (f) a run time Vxworks operating system from WindRiver Systems, Inc.; or (g) an appliance-based operating system, such as that implemented in handheld computers or personal data assistants (PDAs) (e.g., PalmOS available from Palm Computing, Inc., and Windows CE available from Microsoft Corporation). The operating system 24 essentially controls the execution of other computer programs, such as that defined by the software 22 of the purchasing system 10, and provides scheduling, input-output control, file and data management, memory management, and communication control and related services.

The I/O devices 18 may include input devices, for example but not limited to, a keyboard, mouse, scanner, microphone, or other input devices. Furthermore, the I/O devices 18 may also include output devices, for example but not limited to, a printer, display, or other output devices. The I/O devices 18 may further include devices that communicate as both inputs and outputs, for instance but not limited to, a modulator/demodulator (modem; for accessing another device, system, or network), a radio frequency (RF) or other transceiver, a telephonic interface, a bridge, a router, or other communication devices.

When the purchasing system 10 is in operation, the processor 12 is configured to execute the software 22 stored within the memory device 14, to communicate data to and from the memory device 14, and to generally control operations of the purchasing system 10 pursuant to the software 22, as defined herein. The software 22 and the O/S 24, in whole or in part, but typically the latter, are read by the processor 12, perhaps buffered within the processor 12, and then executed.

When the purchasing system 10 is implemented in software, it should be noted that the purchasing system 10 can be stored on any computer readable medium for use by or in connection with any computer related system or method. In the context of this document, a computer readable medium is an electronic, magnetic, optical, or other physical device or means that can contain or store a computer program for use by or in connection with a computer related system or method. The purchasing system 10 can be embodied in any computer readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In an alternative embodiment, where the purchasing system 10 is implemented in hardware, the purchasing system 10 can be implemented with any or a combination of the following technologies, which are each well known in the art: a discrete logic circuit(s) having logic gates for implementing logic functions upon data signals; an application specific integrated circuit (ASIC) having appropriate combinational logic gates; a programmable gate array(s) (PGA); and a field programmable gate array (FPGA), among others.

As described above, the processor 12 is arranged to receive commodity-pricing information through the computer network 16 periodically and to store the commodity-pricing information in the commodity database of the memory device 14. How frequently commodity-pricing information is received may be determined by how frequently commodity-providing sources update their pricing. The commodity-pricing information may be received daily and may be received at hours a business of the user is closed, wherein the processor 12 may otherwise be idle.

Commodity-pricing information may also be received through other sources. A user may manually enter commodity-pricing information using the I/O devices 18. This technique may be preferred when entering private contracts with vendors. A user may receive commodity-pricing information electronically without using the computer network 16. Those having ordinary skill in the art will recognize there are numerous means for conveying information between disparate locations and those means of conveying information are considered to be within the scope of the present invention.

The commodity-pricing information is stored in a commodity database within the memory device 14. The memory device 14 may be located proximate to the processor 12 on a premise of the user, wherein the memory device 14 and the processor 12 are part of a personal computer system of the user. By uploading commodity-pricing information from remote locations on the personal computer system, a user may be able to search for a specific commodity while offline. Further, searching for the specific commodity through the memory device 14 may be completed more quickly by performing the search offline.

The memory device 14 may be located proximate to the processor 12 at a location remote from the user, wherein the memory device 14 and the processor 12 are part of a server, accessible to the user through a computer network. This arrangement may allow most of the intensive periodic updates to be performed at a single location with minimal uploading of data to the personal computer of a user. Other, similar hardware arrangements may be known to those having ordinary skill in the art and are considered to be within the scope of the present invention.

At least one input/output (I/O) device 18 is in communication with the processor 12, through which a specific commodity may be identified.

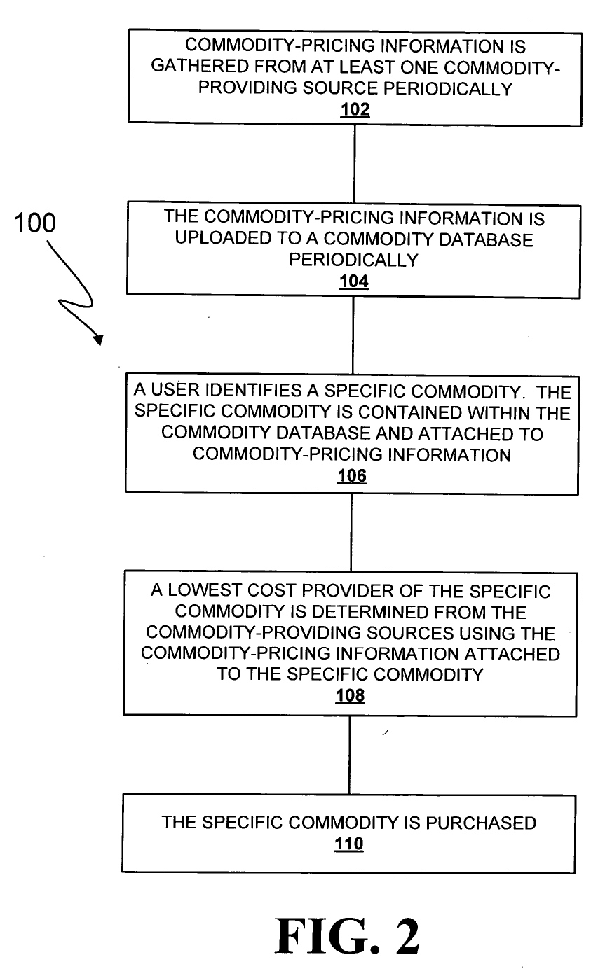

FIG. 2 is a flowchart illustrating a method 100 of practicing the purchasing system 10 of FIG. 1, in accordance with the first exemplary embodiment of the invention. It should be noted that any process descriptions or blocks in flow charts should be understood as representing modules, segments, portions of code, or steps that include one or more instructions for implementing specific logical functions in the process, and alternate implementations are included within the scope of the present invention in which functions may be executed out of order from that shown or discussed, including substantially concurrently or in reverse order, depending on the functionality involved, as would be understood by those reasonably skilled in the art of the present invention.

As is shown by block 102, commodity-pricing information is gathered from at least one commodity-providing source periodically. The commodity-pricing information is uploaded to a commodity database periodically (block 104). A user identifies a specific commodity. The specific commodity is contained within the commodity database and attached to commodity-pricing information (block 106). A lowest cost provider of the specific commodity is determined from the commodity-providing sources using the commodity-pricing information attached to the specific commodity (block 108). The specific commodity is purchased (block 110).

As shown in blocks 102 and 104, commodity-pricing information is gathered and uploaded periodically. It may be convenient for a computer system to perform the gathering and uploading during off-peak hours, which may include weekend time, late evenings, or early mornings. As such, it may be convenient for the periodic gathering and uploading to occur every evening, every early morning, or every weekend. A period for gathering and uploading commodity-pricing information may be influenced by how frequently commodity-providing sources change commodity-pricing and how frequently commodities are purchased.

Commodity-pricing information may come from a variety of sources. Commodity-pricing information may come from electronic catalogs of commodity-providing sources. Commodity-pricing information may come from electronic pricing information belonging to third parties. Commodity-pricing information may come through electronic pricing data for group purchasing organizations. Commodity-pricing information may come through special private contracts with specific commodity-providing sources. Commodity-pricing information from any source may also be manually entered into the system. Commodity-pricing information may come from a single source, such as a single wholesaler of commodities using this technology to assist buyers sorting through its selections. Other sources for commodity-pricing information may exist as would be known to those having experience in the various commodity industries and these sources are also considered to be within the scope of the invention.

Commodity-pricing information may include inventory information provided by commodity-providing sources. The inventory information may be used to determine if a commodity-providing source has enough stock to handle a volume of an order placed for a specific commodity. If the inventory information reveals a commodity-providing source is not capable of filling an order placed for a specific commodity, that commodity-providing source may get filtered out or otherwise excluded from the determination of the lowest cost provider. Otherwise, the commodity-providing source may simply get flagged as not being capable of independently filling the volume of the order, such that a purchase from a second commodity-providing source will need to be made to fill the volume of the order.

As shown in block 108, a lowest cost provider for a specific commodity is determined. The lowest cost provider may be determined when a user identifies the specific commodity. The lowest cost provider may be performed after or concurrently with the steps of gathering and uploading (blocks 102 and 104) the commodity-pricing information and before a user identifies the specific commodity. The purchasing system 10 may identify a lowest cost provider for every commodity uploaded to the memory device 14 every time new commodity-pricing information is uploaded. Then, when a user identifies a specific commodity to be purchased, the purchasing system 10 may recall the previously determined lowest cost provider for that specific commodity from the memory device 14.

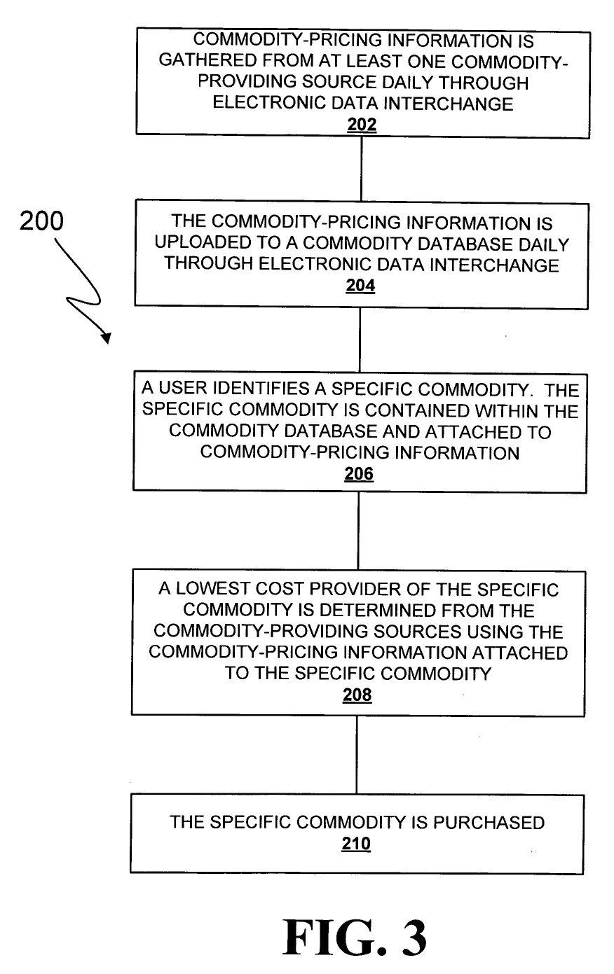

FIG. 3 is a flowchart illustrating a method 200 of practicing the purchasing system 10 of FIG. 1, in accordance with a second exemplary embodiment of the invention. Commodity-pricing information is gathered from at least one commodity-providing source daily through Electronic Data Interchange (hereinafter, “EDI”) (block 202). The commodity-pricing information is uploaded to a commodity database daily through EDI (block 204). A user identifies a specific commodity. The specific commodity is contained within the commodity database and attached to commodity-pricing information (block 206). A lowest cost provider of the specific commodity is determined from the commodity-providing sources using the commodity-pricing information attached to the specific commodity (block 208). The specific commodity is purchased (block 210).

As shown in blocks 202 and 204, commodity-pricing information is gathered and uploaded. The commodity-pricing information may be gathered and uploaded using a computer network, by manually entering data into a computer system, or by other means known to those having ordinary skill in the art with regards to data communication. The commodity-pricing information may be gathered and uploaded using Electronic Data Interchange over the computer network.

Electronic Data Interchange, also known to those having ordinary skill in the art as EDI, is the transfer of data between different companies using networks, such as the Internet. EDI is a mechanism for businesses to buy, sell, and trade information with other businesses. The American National Standards Institute has approved a set of EDI standards known as ASC X12 standards for the transfer of data. EDI is presently a mechanism for exchanging pricing data, for instance, between pharmaceutical providers and pharmacies.

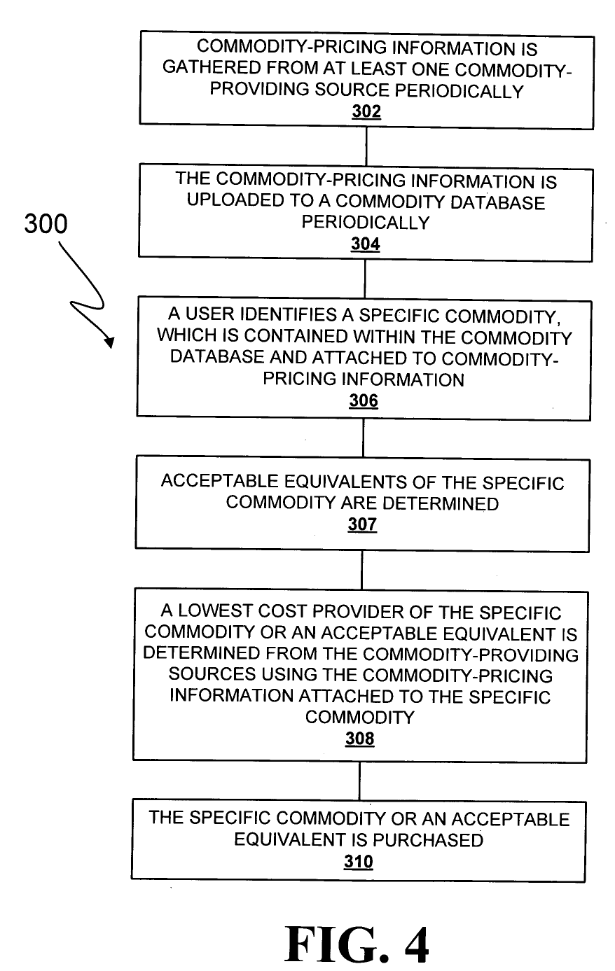

FIG. 4 is a flowchart illustrating a method 300 of practicing the purchasing system 10 of FIG. 1, in accordance with a third exemplary embodiment of the invention. As is shown by block 302, commodity-pricing information is gathered from at least one commodity-providing source periodically. The commodity-pricing information is uploaded to a commodity database periodically (block 304). A user identifies a specific commodity, which is contained within the commodity database and attached to commodity-pricing information (block 306). Acceptable equivalents of the specific commodity are determined (block 307). A lowest cost provider of the specific commodity or an acceptable equivalent is determined from the commodity-providing sources using the commodity-pricing information attached to the specific commodity (block 308). The specific commodity or an acceptable equivalent is purchased (block 310).

The method 300 may include a user or other information source providing acceptable commodity equivalents information. Specifically, the purchasing system 10 may have, in addition to commodities within the commodity database attached to commodity-pricing information, commodities within the database attached to groupings of equivalent commodities and commodity-pricing information attached to the equivalent commodities. For instance, an electrical contractor may enter a sixty-Watt, cold white bulb manufactured by a specific manufacturer as a specific commodity. The purchasing system 10 may return pricing for the sixty-Watt, cold white bulbs manufactured by the specific manufacturer, as well as pricing for other sixty-Watt bulbs by different manufacturers and of other white shades. In this manner, the purchasing system 10 returns equivalent commodities a user may be able to use that offer a cost advantage over the entered specific commodity.

The method 300 may also provide acceptable commodity equivalents information achieved through filtering. In the preceding hypothetical, it was suggested the purchasing system 10 may provide pricing for other sixty-Watt bulbs by different manufacturers and of other white shades. The purchasing system 10 may, in another embodiment, begin with pricing for other sixty-Watt bulbs by different manufacturers and of other white shades, then filter out light bulbs that do not match filtering characteristics entered by the user. For instance, a filter may be in place to remove all products from one specific manufacturer with whom the user has had a bad experience. Once the set of light bulbs is filtered down from the grouping of equivalent commodities to acceptable equivalents, pricing of those acceptable equivalents may be provided to the user. As used herein, “acceptable equivalents” shall be those equivalents from the grouping of equivalent commodities that have not been filtered out and the “filtered equivalents” shall be those equivalents from the grouping of equivalent commodities that have been filtered out.

A user may use a specific filter for the purchase of a specific commodity or a global filter for all commodity purchases. A global filter might include purchasing goods only from specific manufacturers, avoiding specific manufacturers, or requiring a specific ‘grade’ equivalent for all purchases. Some commodity industries have neutral bodies that grade out equivalents from various manufacturers, helping to specify which equivalents are acceptable and making this latter global filter possible. If multiple commodity-providing sources carry the same specific commodity at the same price, a global filter may also be used to identify the preferred commodity-providing source in that situation.

Filters may also be designed that are industry specific. In the pharmaceutical industry, a filter may be designed by or for an insurance carrier. Each insurance carrier and/or coverage plan may contain a list of drug items covered by a plan. That insurance carrier will reimburse only covered drugs. A filter may be designed such that only pharmaceuticals covered by that insurance carrier are permitted to be acceptable equivalents. This filter may be applied if the pharmacy has patients covered by a carrier and/or plan. Managed care carriers may operate similarly.

A filter may be designed for Medicare or Medicaid. Under Medicare, each state may have one or more Prescription Drug Plans (PDP). Each PDP may have a specific list of covered drugs. Only covered drugs can be reimbursed by the PDP. A filter may be applied to only allow PDP drugs to be acceptable equivalents if the pharmacy has patients covered by the PDP. Under Medicaid, each state decides whether or not a product is covered by their Medicaid program (usually a decision based on the manufacturer offering the state a rebate). This information can change monthly and is public or can be purchased from various providers. Medicaid can reimburse only covered items and the covered items can vary by state. A Medicaid filter may be applied to only allow drugs covered by the Medicaid program of the appropriate state to be acceptable equivalents.

The Food and Drug Administration (FDA) of the United States Government provides approved drug products with therapeutic equivalence evaluations. The FDA codifies these evaluations in a reference known in the industry as the Orange Book. The Orange Book uses a two-character alphanumeric code that identifies the equivalence ratings assigned to an approved prescription product according to the FDA evaluation. Two-character alphanumeric codes that begin with the letter “A” are typically considered acceptable equivalents by the FDA, while the FDA does not consider codes that begin with the letter “B” or “Z” acceptable equivalents. A sample of alphanumeric codes that begin with the letter “A” and brief descriptions of the meaning of the codes include:
AA—Products with no known bioequivalence problems in conventional dosage forms.
AB—Products meeting necessary bioequivalence requirements.
AN—Solutions and powders for aerosolization that are marketed for use in any of several delivery systems. Drugs that are marketed for only single delivery system or are a component of a specific delivery system are not included.
AO—Injectable oils with identical active ingredients, concentration, and type of oil.
AP—Injectable aqueous solutions including dry powders, concentrated solutions, or ready-to-use solutions are considered pharmaceutically and therapeutically equivalent if they produce the same concentration and are labeled similarly.
AT—Topical products therapeutically equivalent in same dosage form.

A sample of alphanumeric codes that begin with the letter “B” or “Z” and brief descriptions of the meaning of the codes include:
B—Products with A or B codes previously assigned; new information raised significant questions which require further FDA investigation and review to determine therapeutic equivalence
BC Controlled-release tablets, controlled-release capsules, and controlled-release injectables unless specifically proven to be equivalent.
BD Active ingredients and dosage forms with documented bioequivalence problems.
BE Enteric coated dosage forms unless proven otherwise to be equivalent.
BN Products in aerosol-nebulizer drug delivery systems that are marketed as a component of or specifically for a particular delivery system.
BP Active ingredients and dosage forms with potential bioequivalence problems.
BR Suppositories or enemas for systemic use unless proven to be equivalent.
BS Products having drug standard deficiencies.
BT Topical products with bioequivalence problems.
BX Insufficient data to determine therapeutic equivalence.
ZA Particular pharmaceutical entity (GCN) looked at but particular labeler was not evaluated.
ZB Particular pharmaceutical entity was not evaluated.
ZC Pharmaceutical entity and labeler evaluated but no therapeutic equivalence rating given. Usually applies to single source drugs.

When the commodities to be purchased are pharmaceuticals, the Orange Book codes may be used to determine acceptable equivalent commodities. For instance, a filter may be arranged in which only alphanumeric codes beginning with the letter “A” can be acceptable equivalent commodities. Other government or international bodies may have other standards that may similarly be used as filtering standards. Other industries may have other formal, industry-wide standards for acceptability of equivalent commodities that may similarly be used as filters.

The method 300 may also display pricing of filtered items. These filtered items may be flagged to avoid an accidental purchase of the items. The benefit of this feature is that a user may, upon consideration of the price of the filtered item, reconsider the relevance of the filter. Simply stated, a cost savings may sometimes motivate individuals to reevaluate the filters on the items being reviewed. The flagging of the filtered item may further contain an explanation of the filter, as appropriate, to further provide a user with information useful to considering purchasing a filtered item.

As shown in block 308, a lowest cost provider for a specific commodity is determined. The lowest cost provider may be determined when a user identifies the specific commodity. The determination may be performed after or concurrently with the steps of gathering and uploading (blocks 302 and 304) the commodity-pricing information and before a user identifies the specific commodity. The purchasing system 10 may identify a lowest cost provider for every commodity in the grouping of equivalent commodities uploaded to the memory device 14 every time new commodity-pricing information is uploaded. Then, when a user identifies a specific commodity to be purchased, the purchasing system 10 may recall the previously determined lowest cost provider for the grouping of equivalent commodities associated with that specific commodity from the memory device 14.

Also, after determining acceptable equivalents, it may be that a single commodity-providing source is providing multiple acceptable equivalents for a given commodity as well as one or more filtered equivalents. It may also be that the purchasing system 10 shows the user multiple equivalents along with their prices and that more than one of the multiple equivalents comes from the same commodity-providing source. That commodity-providing source may be identified as the lowest cost provider based on the price for only one of the acceptable equivalents that the commodity-providing source provides.

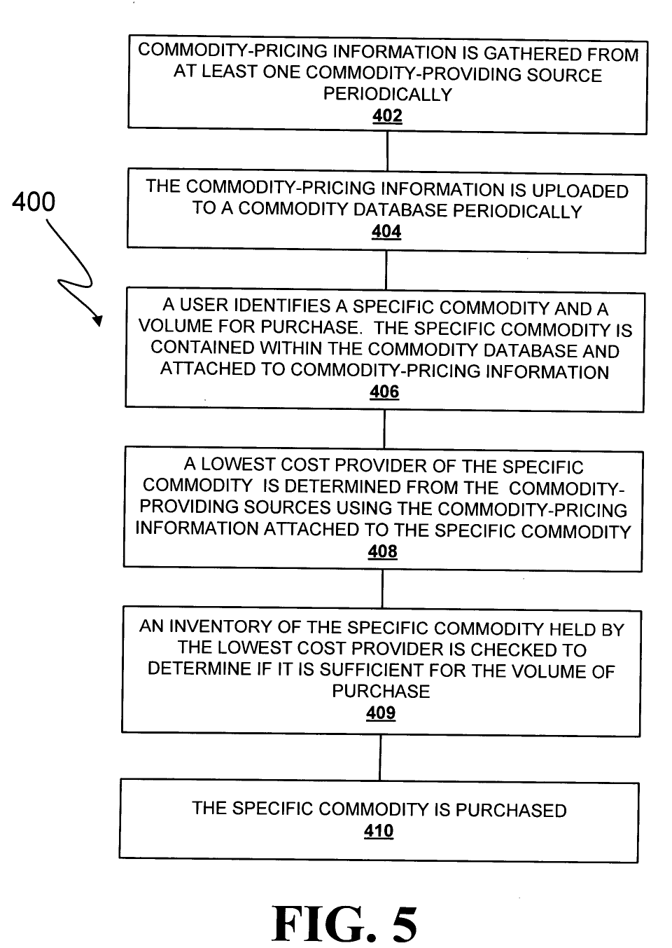

FIG. 5 is a flowchart illustrating a method 400 of practicing the purchasing system 10 of FIG. 1, in accordance with a fourth exemplary embodiment of the invention. As is shown by block 402, commodity-pricing information is gathered from at least one commodity-providing source periodically. The commodity-pricing information is uploaded to a commodity database periodically (block 404). A user identifies a specific commodity and a volume for purchase. The specific commodity is contained within the commodity database and attached to commodity-pricing information (block 406). A lowest cost provider of the specific commodity is determined from the commodity-providing sources using the commodity-pricing information attached to the specific commodity (block 408). An inventory of the specific commodity held by the lowest cost provider is checked to determine if it is sufficient for the volume of purchase (block 409). The specific commodity is purchased (block 410).

The user may enter in quantities or volume of the specific commodity to be purchased when identifying the specific commodity. Quantities may have an impact on a purchase price and the commodity-pricing information may include at least some quantity-related commodity-pricing information. Some commodity-providing sources may also offer discounts or other pricing benefits related to volume of sales, measured in count, currency, or another metric, of a plurality of commodities. The purchasing system 10 may identify achieved and/or achievable volume discounts and associate that information with the commodity-pricing information.

Commodity-pricing information may change frequently. The purchasing system 10 may be capable of analyzing commodity-pricing information into a future date. The purchasing system 10 may further return commodity-pricing information for a plurality of possible purchasing dates and/or times. The purchasing system 10 may further identify a lowest cost of an acceptable equivalent of the specific commodity based, at least partially, on date of purchase over a date range. The purchasing system 10 may be programmed to make a purchase at a point in the future. The purchasing system 10 may post a message to the user whenever the identity of a lowest priced commodity, within a grouping of equivalent commodities and/or acceptable equivalents, changes. The purchasing system 10 may similarly inform the user when members of the grouping of equivalent commodities changes, for instance, due to companies adding or removing offered products or the like.

Data relating to commodity pricing for a specific period (day, week, etc.) may be retained in the memory device 14 after the specific period has passed. When lowest cost providers for each grouping of equivalent commodities are calculated for a new period, a report may be generated showing changes in the lowest cost provider list for each grouping of equivalent commodities for the new period. A report may similarly be generated showing changes in the lowest cost for each grouping of equivalent commodities for the new period. Similar lists may be generated for new commodities available, changes in commodities available from specific commodity-providing sources, volume pricing changes, and other changes in the commodity-pricing information that a user may find useful.

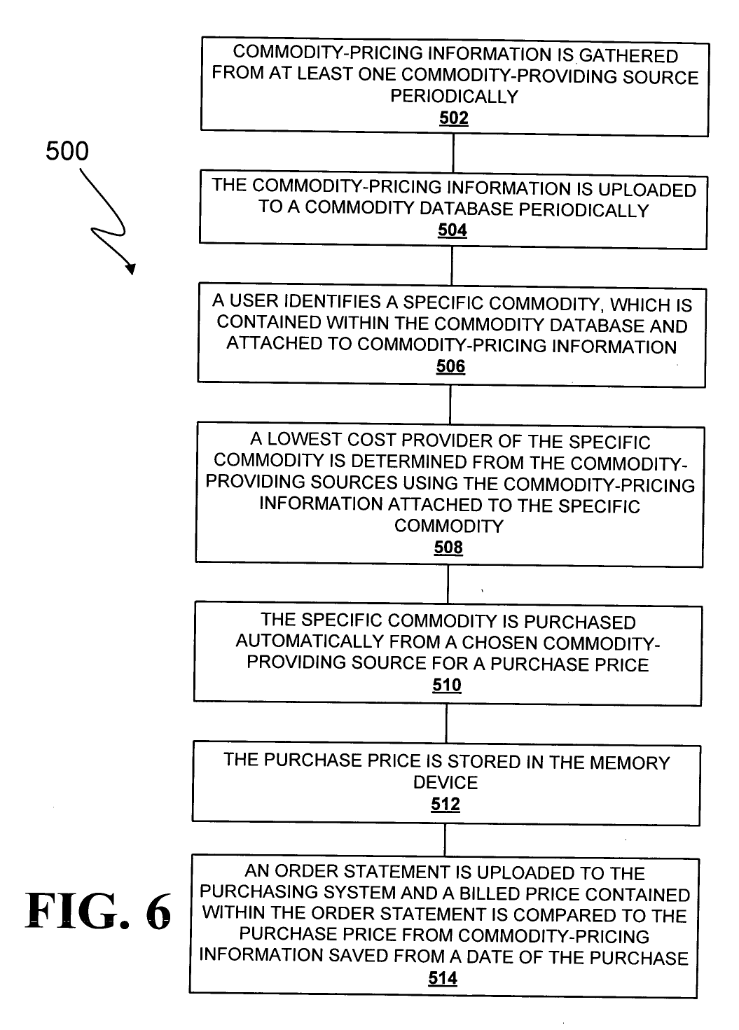

FIG. 6 is a flowchart illustrating a method 500 of practicing the purchasing system 10 of FIG. 1, in accordance with a fifth exemplary embodiment of the invention. Commodity-pricing information is gathered from at least one commodity-providing source periodically (block 502). The commodity-pricing information is uploaded to a commodity database periodically (block 504). A user identifies a specific commodity, which is contained within the commodity database and attached to commodity-pricing information (block 506). A lowest cost provider of the specific commodity is determined from the commodity-providing sources using the commodity-pricing information attached to the specific commodity (block 508). The specific commodity is purchased automatically from a chosen commodity-providing source for a purchase price (block 510). The purchase price is stored in the memory device (block 512). An order statement is uploaded to the purchasing system 10 and a billed price contained within the order statement is compared to the purchase price from commodity-pricing information saved from a date of the purchase (block 514).

As shown in block 510, the specific commodity is purchased. The user is not required to purchase the specific commodity at the lowest price located, although the user may. The user may make the purchase over the computer network or through other communication means with a commodity-providing source. Further, the user may allow the purchasing system 10 to automatically make the purchase of the specific commodity or an acceptable equivalent. The user may require approval of any acceptable equivalents substituted for the specific commodity before beginning the automated purchase. The purchasing system 10 may utilize purchase order numbers stored in the memory device 14. The purchasing system 10 may utilize purchase order numbers assigned by a user when the specific commodity is identified for purchase. The purchasing system 10 may further store the purchase in the memory device 14 and/or generate a hard copy of the purchase order.

As shown in block 512, the method 500 may further include receiving billing from the commodity-providing source through the purchasing system 10. Billing information may be received over the computer network from the commodity-providing source. Billing information may be provided through the commodity-providing source using EDI.

As shown in block 514, a billed price within the order statement, sent by the commodity-providing source, may be compared to a purchasing price. The purchasing price may be gleaned from the purchase order stored in the memory device 14. The purchasing price may be collected from the commodity-pricing information stored from a date of purchase.

The order statement, for instance, may be a purchase order acknowledgement or an invoice. The order statement may contain the billed price, the ordered quantity, and the ordered commodity. If the billed price is not equivalent to the purchasing price, the user may be alerted. Similarly, if the ordered quantity does not match a purchasing quantity or the ordered commodity does not match the specific commodity purchased, the user may be alerted. Comparing the purchase order to the order statement may similarly be performed to check other purchasing information. Research has shown, for example, billed prices vary, errantly, from purchasing prices in as many as one percent of all orders billed in some industries. This step in the method 500 may work to insure that when the user agrees to purchase a commodity at a low price, the user is billed that same low price.

As previously mentioned, the user is not required to purchase the specific commodity or acceptable equivalent at the lowest price identified, although the user may. Should the user choose to purchase the specific commodity from a second provider at a price above the lowest price identified, the purchasing system 10 may track a cost difference between purchasing the specific commodity from the lowest cost provider and purchasing the specific commodity from the second provider. This feature may, for instance, be used to calculate a cost for remaining loyal to a specific commodity-providing source. This feature may also be useful if a vendor does not have the lowest priced commodity and a purchaser wishes to track the cost of having to purchase a higher priced commodity.

The user may arrange a filter in the purchasing system 10 such that none of the other commodities in the grouping of equivalent commodities will be an acceptable equivalent for the specific commodity. Such a filter will cause the specific commodity to be selected irrespective of prices of the grouping of equivalent commodities. However, a lowest priced filtered equivalent will also be presented to the user such that the user may perform a price comparison for the purpose of considering accepting a filtered equivalent. The filtered equivalent may appear flagged to the user, such that the user is able to easily discern that the good is not the specific commodity.

A user may enter a volume of the specific commodity to be purchased at the time of determining the lowest priced acceptable equivalent. Volume to be purchased often has a direct impact on pricing for the commodity. The purchasing system 10 may return, in addition to other pricing information, a lowest priced acceptable equivalent for a larger volume purchase. The pricing for this entry may be flagged such that the user is able to easily discern that the volume priced requires a purchase exceeding the volume desired. This commodity-pricing information may be presented to the user such that the user may consider making a larger volume purchase to enjoy the pricing advantage. This commodity-pricing information is a bulk item entry.

As shown in block 508, a lowest cost provider of the specific commodity is determined from the commodity-providing sources using the commodity-pricing information attached to the specific commodity. The purchasing system 10 may be designed such that the a lowest cost provider of the specific commodity identified or an acceptable equivalent at a volume indicated is determined, a lowest cost provider of a filtered equivalent of the specific commodity at a volume indicated is determined, and a lowest cost provider of the specific commodity or an acceptable equivalent at a greater than volume indicated is determined. These three prices may then be presented to a user such that a user may reconsider the filter or the volume indicated to achieve a lower price. The purchasing system 10 may be designed to display only determined prices and descriptions of commodities from these three presented commodities to provide the user with a limited number of choices, which may expedite purchasing decisions.

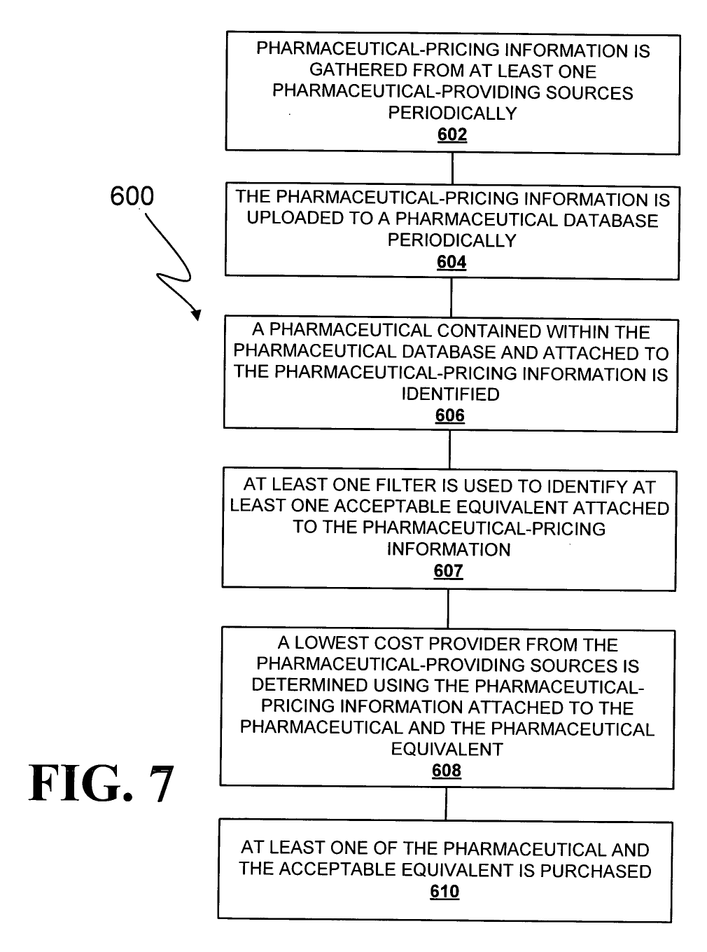

FIG. 7 is a flowchart illustrating a method 600 of practicing the purchasing system 10 of FIG. 1, in accordance with a sixth exemplary embodiment of the invention. Pharmaceutical-pricing information is gathered from at least one pharmaceutical-providing sources periodically (block 602). The pharmaceutical-pricing information is uploaded to a pharmaceutical database periodically (block 604). A pharmaceutical contained within the pharmaceutical database and attached to the pharmaceutical-pricing information is identified (block 606). At least one filter is used to identify at least one acceptable equivalent attached to the pharmaceutical-pricing information (block 607). A lowest cost provider from the pharmaceutical-providing sources is determined using the pharmaceutical-pricing information attached to the pharmaceutical and the pharmaceutical equivalent (block 608). At least one of the pharmaceutical and the acceptable equivalent is purchased (block 610). The filter shown in block 607 may utilize equivalents information from a Food and Drug Administration Orange Book.

It should be emphasized that the above-described embodiments of the present invention are merely possible examples of implementations, simply set forth for a clear understanding of the principles of the invention. Many variations and modifications may be made to the above-described embodiments of the invention without departing substantially from the spirit and principles of the invention. All such modifications and variations are intended to be included herein within the scope of this disclosure and the present invention and protected by the following claims.

I claim:

1. A method of purchasing a commodity at a low price, the method comprising the steps of:
gathering commodity-pricing information from at least one commodity-providing source periodically;
uploading the commodity-pricing information to a commodity database periodically;
identifying a specific commodity contained within the commodity database and attached to commodity-pricing information;
determining a lowest cost provider from the commodity-providing sources using the commodity-pricing information attached to the specific commodity; and
purchasing the specific commodity.

2. The method of claim 1, wherein the steps of gathering and uploading are completed daily.

3. The method of claim 1, wherein the steps of gathering and uploading are performed through a computer network.

4. The method of claim 1, further comprising the steps of:
providing acceptable commodity equivalents information; and
determining an acceptable lowest cost provider from the commodity-providing sources using the commodity-pricing information attached to the acceptable commodity equivalents.

5. The method of claim 1, wherein the step of purchasing further comprises purchasing the specific commodity over a computer network using the commodity-pricing information.

6. The method of claim 5, further comprising:
receiving an order statement over the computer network;
comparing a billed price within the order statement to a purchasing price within the commodity-pricing information; and
alerting a user when the billed price is not equivalent to the purchasing price for the specific commodity.

7. The method of claim 1, wherein the specific commodity is purchased from a second provider, further comprises tracking a cost difference between purchasing the specific commodity from the lowest cost provider and purchasing the specific commodity from the second provider.

8. The method of claim 1, wherein the steps of gathering and uploading further comprises utilizing Electronic Data Interchange to gather and upload commodity-pricing information.

9. The method of claim 1, further comprising receiving inventory information from the commodity-providing sources periodically.

10. The method of claim 9, wherein the step of determining the lowest cost provider further comprises determining the lowest cost provider, from the commodity-providing sources having a sufficient inventory to provide the specific commodity, using the commodity-pricing information attached to the specific commodity

11. A system for purchasing a commodity at a low price, the system comprising:
means for gathering commodity-pricing information from at least one commodity-providing source periodically;
means for uploading the commodity-pricing information to a commodity database periodically;
means for identifying a specific commodity contained within the commodity database and attached to commodity-pricing information;
means for determining a lowest cost provider from the commodity-providing sources using the commodity-pricing information attached to the specific commodity; and
means for purchasing the specific commodity.

12. The system of claim 11, wherein the means for purchasing the specific commodity further comprises means for automatically purchasing the specific commodity.

13. The system of claim 12, further comprising:
means for receiving billing information;
means for automatically comparing a billed price within the billing information to a purchasing price within the commodity-pricing information; and
means for alerting a user when the billed price is not equivalent to the purchasing price for the specific commodity.

14. The system of claim 13, further comprising:
means for automatically comparing a billed commodity within the billing information to a purchasing commodity within the commodity-pricing information;
means for alerting the user when the billed commodity is not equivalent to the purchasing commodity for the specific commodity, thereby alerting the user that a different commodity was billed for by the commodity-providing source than was purchased;
means for automatically comparing a billed volume within the billing information to a purchasing volume within the commodity-pricing information; and
means for alerting the user when the billed volume is not equivalent to the purchasing volume for the specific commodity, thereby informing the user a different volume was billed by the commodity-providing source than was purchased.

15. The system of claim 11, further comprising:
means for identifying acceptable equivalents for the specific commodity; and
means for determining the lowest cost provider from the commodity-providing sources using the commodity-pricing information attached to the acceptable equivalents.

16. The system of claim 11, further comprising means for tracking a difference between a purchase price for the specific commodity purchased and a lowest price received from the lowest cost provider.

17. The system of claim 11, further comprising means for receiving inventory information from the commodity-providing sources periodically.

18. The system of claim 17, wherein the means for determining the lowest cost provider further comprises means for determining the lowest cost provider, from the commodity-providing sources who have a sufficient inventory to supply the specific commodity, using the commodity-pricing information attached to the specific commodity.

19. The system of claim 11, wherein the means for gathering commodity-pricing information further comprises means for utilizing Electronic Data Interchange for gathering commodity-pricing information.

20. The system of claim 11, further comprising:
means for identifying a volume of the specific commodity to be purchased;
means for presenting lowest cost pricing for: the specific commodity identified; an equivalent; and for a bulk item entry, wherein lowest cost pricing for the bulk item entry is pricing for an acceptable equivalent purchased at a volume greater than the identified volume.

21. A method of sorting pharmaceutical-pricing information, the method comprising the steps of:
gathering pharmaceutical-pricing information from at least one pharmaceutical-providing source periodically;
uploading the pharmaceutical-pricing information to a pharmaceutical database periodically;
identifying a pharmaceutical contained within the pharmaceutical database and attached to the pharmaceutical-pricing information;
using at least one filter to identify at least one acceptable equivalent attached to the pharmaceutical-pricing information, wherein the pharmaceutical and the acceptable equivalent combine to form a pharmaceutical grouping;
determining a lowest cost pharmaceutical within the pharmaceutical grouping using the pharmaceutical-pricing information attached to the pharmaceutical and the acceptable equivalent; and
purchasing at least one of the pharmaceutical and the acceptable equivalent.

22. The method of claim 21, wherein the at least one filter utilizes equivalents information from a Food and Drug Administration Orange Book.

23. The method of claim 21, further comprising tracking a price difference between the purchased pharmaceutical and a second pharmaceutical.
